(19) United States
(12) Patent Application Publication
(10) Pub. No.: US 2024/0338615 A1
(43) Pub. Date: Oct. 10, 2024

(54) SYSTEMS AND METHODS FOR PREDICTING AIRPORT PASSENGER FLOW

(71) Applicant: University of Cincinnati, Cincinnati, OH (US)

(72) Inventors: Javier Viana, Cincinnati, OH (US); Kelly Cohen, Mason, OH (US)

(73) Assignee: University of Cincinnati, Cincinnati, OH (US)

(21) Appl. No.: 18/682,665

(22) PCT Filed: Aug. 12, 2022
(86) PCT No.: PCT/US2022/040167

§ 371 Date: Feb. 9, 2024

Related U.S. Application Data
(60) Provisional application No. 63/232,782, filed on Aug. 13, 2021.
(60) Provisional application No. 63/330,887, filed on Apr. 14, 2022.

(51) Int. Cl. G06Q 10/04; G06Q 10/02; G06Q 50/40

(52) U.S. Cl. CPC G06Q 10/04; G06Q 10/02; G06Q 50/40

(57) ABSTRACT

A computing device includes a controller to receive passenger data based on airport scans of boarding passes, determine time until takeoff data for passengers, determine passenger flow histograms based on the time until takeoff data, transform the passenger flow histograms into continuous passenger flow profile curves, determine input similarity matrices between a first flight and past flights having scheduled departures on the same day of the week based on input similarity scores, determine output similarity matrices between the first flight and the past flights based on passenger flow profile curves associated with the first flight and the past flights, determine past flights that are most similar to the first flight based on the input similarity matrices and the output similarity matrices, and determine a predicted passenger flow profile curve for the first flight based on the passenger flow profile curves associated with the most similar past flights.

### CROSS-REFERENCE TO RELATED APPLICATION

This application claims priority to U.S. Provisional Application No. 63/232,782 filed on Aug. 13, 2021 and U.S. Provisional Application No. 63/330,887 filed on Apr. 14, 2022, which are incorporated herein by reference in their entireties.

### TECHNICAL FIELD

The present specification relates to systems and methods for predicting airport passenger flow, and more particularly, to an AI process for predicting passenger flow at the security checkpoint of an airport.

### BACKGROUND

Millions of passengers pass through airports and airport security checkpoints at thousands of airports in the United States every year. As these passengers move through an airport to board their scheduled flights, airports must employ numerous resources to manage this passenger flow. For example, airports may desire to ensure that sufficient staff are available to process passengers at check-in, security checkpoints, boarding gates, food courts and the like. The amount of staff and other resources needed at a particular airport at a particular time may depend upon the number of passengers present in the airport at that time. Accordingly, it may be desirable to predict airport passenger flow.

### SUMMARY

In an embodiment, a computing device may include a controller configured to receive passenger data associated with a plurality of passengers based on scans of boarding passes associated with the plurality of passengers at an airport, determine time until takeoff data for the plurality of passengers based on the passenger data, the time until takeoff data for a passenger comprising a relative difference between a time when the passenger's boarding pass was scanned and a departure time of a flight associated with the passenger's boarding pass, determine one or more passenger flow histograms for one or more flights based on the time until takeoff data, each passenger flow histogram indicating a number of passengers having a time until takeoff within each of a predetermined number of time intervals before a scheduled flight, transform the passenger flow histograms into one or more continuous passenger flow profile curves, determine one or more input similarity matrices between a first flight and a plurality of past flights based on input similarity scores between the first flight and the plurality of past flights, the first flight and the past flights having scheduled departures on the same day of the week, determine one or more output similarity matrices between the first flight and the plurality of past flights based on passenger flow profile curves associated with the first flight and the plurality of past flights, determine a predetermined number of the plurality of past flights that are most similar to the first flight based on the one or more input similarity matrices and the one or more output similarity matrices, and determine a predicted passenger flow profile curve for the first flight based on the passenger flow profile curves associated with the predetermined number of the plurality of past flights.

In another embodiment, a method may include receiving passenger data associated with a plurality of passengers based on scans of boarding passes associated with the plurality of passengers at an airport, the passenger data comprising a flight number, a departure date and time, a destination airport, and an airline associated with a passenger's scheduled flight, and a time that the passenger's boarding pass was scanned, determining time until takeoff data for the plurality of passengers based on the passenger data, the time until takeoff data for a passenger comprising a relative difference between a time when the passenger's boarding pass was scanned and a departure time of a flight associated with the passenger's boarding pass, determining one or more passenger flow histograms for one or more flights based on the time until takeoff data, each passenger flow histogram indicating a number of passengers having a time until takeoff within each of a predetermined number of time intervals before a scheduled flight, transforming the passenger flow histograms into one or more continuous passenger flow profile curves, determining one or more input similarity matrices between a first flight and a plurality of past flights based on input similarity scores between the first flight and the plurality of past flights, the first flight and the past flights having scheduled departures on the same day of the week, determining one or more output similarity matrices between the first flight and the plurality of past flights based on passenger flow profile curves associated with the first flight and the plurality of past flights, determining a predetermined number of the plurality of past flights that are most similar to the first flight based on the one or more input similarity matrices and the one or more output similarity matrices, and determining a predicted passenger flow profile curve for the first flight based on the passenger flow profile curves associated with the predetermined number of the plurality of past flights.

In another embodiment, a system may include a scanning device and a computing device. The scanning device may scan boarding passes of airport passengers. The computing device may receive passenger data associated with a plurality of passengers from the scanning device, determine time until takeoff data for the plurality of passengers based on the passenger data, the time until takeoff data for a passenger comprising a relative difference between a time when the passenger's boarding pass was scanned and a departure time of a flight associated with the passenger's boarding pass, determine one or more passenger flow histograms for one or more flights based on the time until takeoff data, each passenger flow histogram indicating a number of passengers having a time until takeoff within each of a predetermined number of time intervals before a scheduled flight, transform the passenger flow histograms into one or more continuous passenger flow profile curves, determine one or more input similarity matrices between a first flight and a plurality of past flights based on input similarity scores between the first flight and the plurality of past flights, the first flight and the past flights having scheduled departures on the same day of the week, determine one or more output similarity matrices between the first flight and the plurality of past flights based on passenger flow profile curves associated with the first flight and the plurality of past flights, determine a predetermined number of the plurality of past flights that are most similar to the first flight based on the one or more input similarity matrices and the one or more output similarity matrices, and determine a predicted passenger flow profile curve for the first flight based on the passenger flow profile curves associated with the predetermined number of the plurality of past flights.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for predicting airport passenger flow, according to one or more embodiments shown and described herein;

FIG. 2 schematically depicts the computing device of FIG. 1, according to one or more embodiments shown and described herein;

FIG. 3A depicts example passenger scan data, according to one or more embodiments shown and described herein;

FIG. 3B depicts an example passenger arrival histogram, according to one or more embodiments shown and described herein;

FIG. 4 graphically depicts a method of determining a continuous passenger flow profile curve, according to one or more embodiments shown and described herein;

FIG. 5 depicts example sinusoidal exponential membership functions that may be used in determining a continuous passenger flow profile curve, according to one or more embodiments shown and described herein;

FIG. 6 graphically depicts a plurality of flight similarity matrices, according to one or more embodiments shown and described herein;

FIG. 7 depicts two example passenger flow profile curves, according to one or more embodiments shown and described herein;

FIG. 8 shows a graphical representation of a calculation of fitness value for a Genetic Algorithm, according to one or more embodiments shown and described herein;

FIG. 9 shows an example generic population of chromosomes that may be used by a Genetic Algorithm, according to one or more embodiments shown and described herein;

FIG. 10 graphically depicts an example recirculation of fittest chromosomes from a Genetic Algorithm, according to one or more embodiments shown and described herein;

FIG. 11 depicts an example daily evolution of an airport's load factor for each day of the week, according to one or more embodiments shown and described herein;

FIG. 12 graphically depicts a transformation from a continuous passenger flow profile curve to a passenger flow histogram, according to one or more embodiments shown and described herein;

FIG. 13 graphically depicts a computational step in the transformation from a continuous passenger flow profile curve to a passenger flow histogram, according to one or more embodiments shown and described herein; and

FIG. 14 depicts a flow chart of an example method that may be performed by the system of FIG. 1, according to one or more embodiments shown and described herein.

### DETAILED DESCRIPTION

The embodiments disclosed herein describe systems and methods for predicting airport passenger flow. Accurate predictions of passenger flow through airports can be valuable to airlines, airports, the Transportation Safety Administration (TSA), and other stakeholders. For example, these entities may allocate staff, arrange queues, tailor advertisements, and optimize other functions based on the number of passengers flowing through an airport at a given time.

In embodiments disclosed herein, passenger flow at an airport may be predicted using a genetic algorithm that determines, for an upcoming flight, past flights that have similar passenger flow. Passenger flow data for these past flights may be used to predict passenger flow for the upcoming flight. For example, the number of passengers expected to arrive at the airport at different times with respect to the upcoming flight may be predicted, as disclosed herein. Predicted passenger flows associated with multiple flights departing from the same terminal at an airport may then be aggregated or merged to determine an overall predicted passenger flow for that terminal, as disclosed herein. This prediction may be made a day or more in advance of one or more scheduled flights. Then, during the day of the one or more flights, data about the actual number of passengers arriving at the airport may be used to dynamically update the prediction, as disclosed herein.

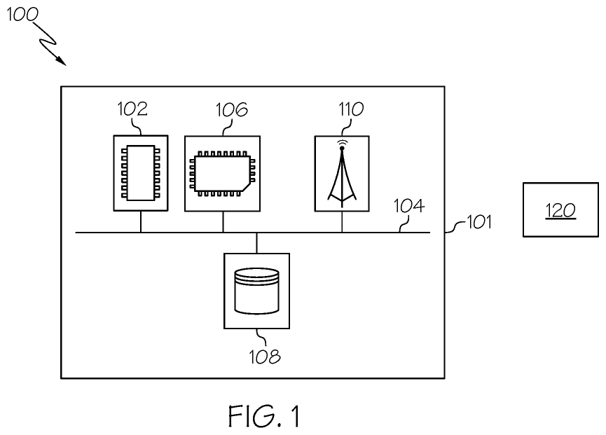

Turning now to the figures, FIG. 1 shows an example system 100 that may predict passenger flow data, according to embodiments described herein. The system 100 includes a computing device 101 and a scanning device 120, which may be communicatively coupled to each other. In the illustrated example of FIG. 1, the computing device 101 and the scanning device 120 are shown as two separate devices. However, in other examples, the computing device 101 and the scanning device 120 may be part of the same physical apparatus.

The computing device 101 of FIG. 1 includes one or more processors 102, a communication path 104, one or more memory modules 106, a data storage component 108, and network interface hardware 110, the details of which will be set forth in the following paragraphs.

Each of the one or more processors 102 may be any device capable of executing machine readable and executable instructions. Accordingly, each of the one or more processors 102 may be a controller, an integrated circuit, a microchip, a computer, or any other physical or cloud-based computing device. The algorithms discussed below may be executed by the one or more processors 102. The one or more processors 102 are coupled to a communication path 104 that provides signal interconnectivity between various modules of the computing device 101. Accordingly, the communication path 104 may communicatively couple any number of processors 102 with one another, and allow the modules coupled to the communication path 104 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth®, Near Field Communication (NFC) and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

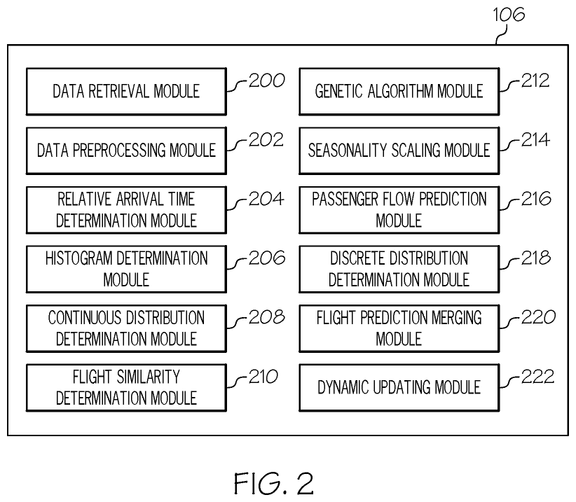

The computing device 101 includes one or more memory modules 106 coupled to the communication path 104. The one or more memory modules 106 may comprise RAM, ROM, flash memories, hard drives, or any device capable of storing machine readable and executable instructions such that the machine readable and executable instructions can be accessed by the one or more processors 102. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 106. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 106 are discussed in more detail below in connection with FIG. 2.

Referring still to FIG. 1, the example computing device 101 includes a data storage component 108. The data storage component 108 may store a variety of data used by the computing device 101, as disclosed herein. For example, the data storage component 108 may store flight data and/or model parameters used by the computing device 101 to predict passenger flow, as disclosed herein.

Still referring to FIG. 1, the computing device 101 comprises network interface hardware 110 for communicatively coupling the computing device 101 to external devices such as the scanning device 120. For example, the network interface hardware 110 may communicatively couple the computing device 101 to the scanning device 120 such that data may be transmitted from the scanning device 120 to the computing device 101. The network interface hardware 110 can be communicatively coupled to the communication path 104 and can be any device capable of transmitting and/or receiving data via a network. Accordingly, the network interface hardware 110 can include a communication transceiver for sending and/or receiving any wired or wireless communication. For example, the network interface hardware 110 may include an antenna, a modem, LAN port, Wi-Fi card, WiMax card, mobile communications hardware, near-field communication hardware, satellite communication hardware and/or any wired or wireless hardware for communicating with other computing devices.

Still referring to FIG. 1, the scanning device 120 may scan boarding passes or other documents associated with airline passengers and may retrieve data associated with the passenger. In embodiments, the scanning device 120 may be an apparatus located at a security checkpoint or elsewhere in an airport. Passengers may be required to scan their boarding pass for security purposes in order to pass through the security checkpoint and board a flight. When the scanning device 120 scans a boarding pass, the scanning device 120 may access a database (e.g., by communicating with an external server maintained by the airport or airline) and may retrieve data associated with the passenger. For example, the scanning device 120 may receive flight information associated with the passenger (e.g., a flight number, destination, and departure time for a flight that the passenger is scheduled to take), the number of bags the passenger has checked in, whether the passenger uses TSA PreCheck, and the time that the boarding pass was scanned. The information retrieved by the scanning device 120 may be transmitted to the computing device 101 and may be utilized by the computing device 101, as disclosed in further detail below.

Referring now to FIG. 2, the one or more memory modules 106 include a data retrieval module 200, a data preprocessing module 202, a relative arrival time determination module 204, a histogram determination module 206, a continuous distribution determination module 208, a flight similarity determination module 210, a genetic algorithm module 212, a seasonality scaling module 214, a passenger flow prediction module 216, a discrete distribution determination module 218, a flight prediction merging module 220, and a dynamic updating module 222. Each of the data retrieval module 200, the data preprocessing module 202, the relative arrival time determination module 204, the histogram determination module 206, the continuous distribution determination module 208, the flight similarity determination module 210, the genetic algorithm module 212, the seasonality scaling module 214, the passenger flow prediction module 216, the discrete distribution determination module 218, the flight prediction merging module 220, and the dynamic updating module 222 may be a program module in the form of operating systems, application program modules, and other program modules stored in one or more memory modules 106. Such a program module may include, but is not limited to, routines, subroutines, programs, objects, components, data structures and the like for performing specific tasks or executing specific data types as will be described below.

The data retrieval module 200 may retrieve data from the scanning device 120 and/or from other computing devices, as disclosed herein. As discussed above, the scanning device 120 may scan boarding passes of passengers in an airport (e.g., at a security checkpoint). After a boarding pass is scanned by the scanning device 120, the scanning device 120 may extract information associated with the boarding pass. This extracted information may be stored by the scanning device 120 and/or transmitted to the computing device 101. In the illustrated example, the scanning device 120 stores data extracted from passenger boarding passes for a plurality of passengers during the day and transmits the extracted data to the computing device 101 at the end of the day. However, in other examples, data may be transmitted from the scanning device 120 to the computing device 101 at other intervals.

In embodiments, the scanning device 120 may retrieve non-identifiable information associated with a passenger's boarding pass. By retrieving non-identifiable information, privacy concerns may be alleviated. In some examples, the scanning device 120 may scan a barcode and retrieve a string of characters associated with the passenger's scheduled flight based on the bar code. In the illustrated example, the information retrieved by the scanning device 120 and transmitted to the computing device 101 after scanning a passenger's boarding pass may include a flight number, a departure date and time, a destination airport, an airline, and a time that the scan occurred. In other examples, the scanning device 120 may retrieve additional information based on a scan of the boarding pass and may transmit this additional information to the computing device 101.

The data retrieval module 200 may also retrieve data from other sources such as a database associated with an airport that includes information about scheduled flights, total number of passengers that pass through the airport every day, and average waiting time at security checkpoints in the airport. This data may be retrieved from a database associated with the airport or other servers or computing devices. In some examples, the data retrieval module 200 may retrieve other data including weather forecasts, traffic reports, scheduled events around the airport, and the like.

The information associated with departing flight schedules retrieved by the data retrieval module 200 may include departure times, destinations, airlines operating the flights, flight numbers, equipment types, and a number of seats associated with each flight scheduled to depart from an airport. The total number of passengers that pass through the airport every day may be used to adjust for seasonality, as disclosed in further detail below. The average waiting time at security checkpoints may be used to adjust for a time lag between when passengers arrive at an airport and when they arrive at a departure gate. The average waiting time may be determined by sensors or other hardware installed in an airport.

Referring still to FIG. 2, the data preprocessing module 202 may perform preprocessing of data received by the data retrieval module 200. In the illustrated example, the data retrieval module 200 receives one data file from the scanning device 120 every day. The received data file may have a plurality of data entries, with each entry corresponding to a scan of a boarding pass. The data preprocessing module 202 may filter the data in the received data file to obtain clean data, as disclosed herein. For example, the data preprocessing module 202 may filter out data entries having missing information, having a departure date not for the current date, having the wrong departure airport, and the like. The data preprocessing module 202 may maintain a record of data entries that were filtered out.

In the illustrated example, the data preprocessing module 202 may sort data entries by flight and store data entries associated with different flights in a different file, referred to herein as curated data files. The data preprocessing module 202 may perform this sorting based on flight number but also other information, since flight numbers may not be unique. That is, different airlines may utilize the same flight number for different flights. Accordingly, the data preprocessing module 202 may consider airline, departure time, and destination, in addition to flight number when sorting data entries by flight. The data preprocessing module 202 may also remove duplicate data entries, which may be caused by scanning or data transmission errors.

Referring still to FIG. 2, the relative arrival time determination module 204 may determine, for each data entry associated with a flight, a relative time that the scan occurred with respect to the departure time of the flight. That is, the relative arrival time determination module 204 may determine how many minutes before a passenger's scheduled flight their boarding pass was scanned. This may indicate how early the passenger arrived at the airport with respect to the departure time of their scheduled flight. This data may be used to predict airport passenger flow, as disclosed herein. As disclosed herein, the relative time between when a boarding pass is scanned and the departure time of the associated flight may be referred to as a time until take-off (TUTO).

Referring still to FIG. 2, the histogram determination module 206 may determine a histogram for a flight, based on the data entries associated with that flight, indicating the TUTO for all boarding passes that were scanned for that flight. Accordingly, the histogram determined by the histogram determination module 206 may represent a snapshot of how early passengers arrived for that particular flight.

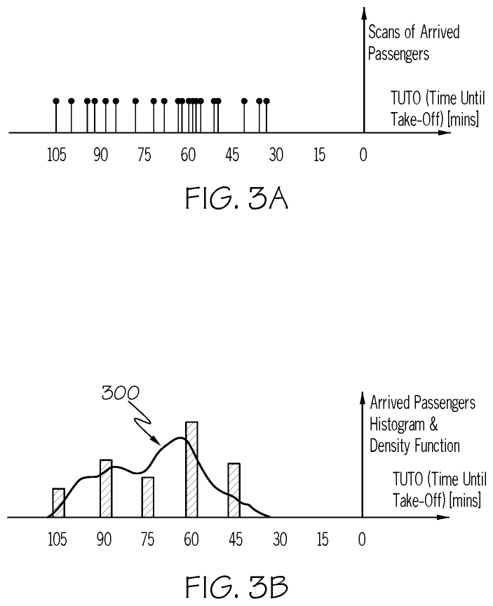

FIG. 3A shows a plot indicating a TUTO for each passenger of a particular flight. In the example of FIG. 3A, the first passenger's boarding pass was scanned about 105 minutes before the flight, the next passenger's boarding pass was scanned about 100 minutes before the flight, and the last passenger's boarding pass was scanned about 35 minutes before the flight. The histogram determination module 206 may group each of these data points indicating a passenger's boarding pass being scanned into bins based on the TUTO.

In the illustrated example, the histogram determination module 206 groups the data points into bins of 15-minute intervals. That is, the histogram determination module 206 may determine how many passengers arrived between 0-15 minutes before the flight, how many passengers arrived between 15-30 minutes before the flight, how many passengers arrived between 30-45 before the flight and so on. However, in other examples, the histogram determination module 206 may group the data points into bins of any other interval. In the illustrated example, the histogram determination module 206 considers a window of 4 hours (240 minutes) before a flight for grouping TUTO data. However, in other examples, any other window of time before a scheduled flight may be considered.

FIG. 3B shows an example histogram that may be created by the histogram determination module 206 based on the data from FIG. 3A. That is, FIG. 3B indicates the number of passengers having a TUTO within each 15-minute interval before a scheduled flight. FIG. 3B also shows an example continuous distribution 300 that may be generated based on the histogram of FIG. 3B, as disclosed in further detail below.

Referring back to FIG. 2, the continuous distribution determination module 208 may transform the histogram determined by the histogram determination module 206 into a continuous distribution, such as the continuous distribution 300 of FIG. 3B, as disclosed herein. While a histogram may provide an accurate indication of the number of passengers whose boarding passes were scanned within each 15-minute interval before a flight, a discrete set of data points that comprise a histogram may be more difficult to manipulate for the other operations of the passenger flow prediction performed by the computing device 101 disclosed herein. Instead, a continuous distribution based on the histogram may be easier to work with for the various mathematical operations performed by the computing device 101. Accordingly, the continuous distribution determination module 208 may transform a discrete histogram into a continuous distribution. The continuous distribution may represent a passenger flow profile curve for a particular flight, indicating passenger flow through the airport for the flight.

To perform this transformation, the continuous distribution determination module 208 utilizes two parameters. The first parameter, t, specifies a separation between every pair of adjacent points in the time axis of the continuous output. The second parameter, w, specifies a length of a sliding window that will traverse the discrete events, weighting the number of data points seen. In the illustrated example, t must be less than or equal to w/2.

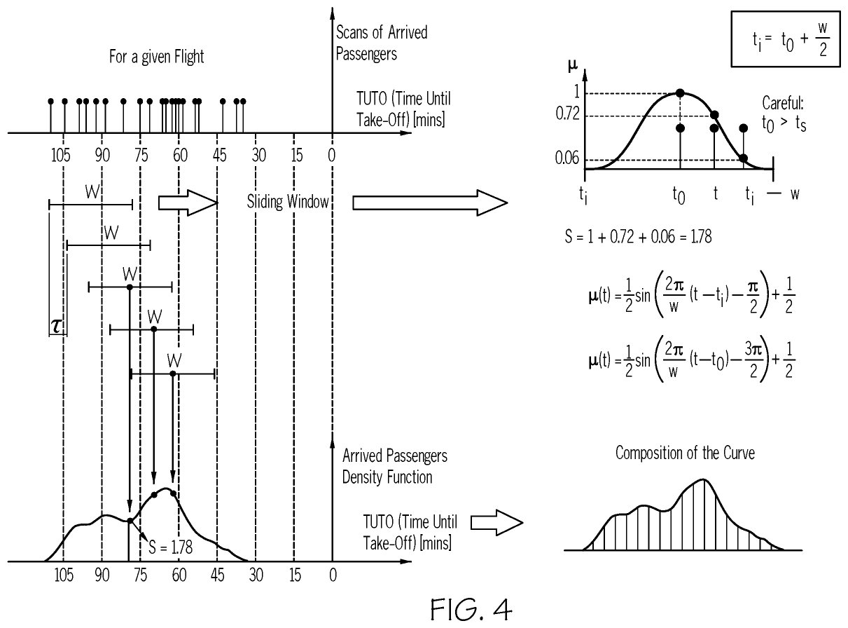

In the illustrated example, for each sliding window, the relative position of a scan is weighted with respect to the center of the window using a sinusoidal distribution as the membership function. This can be seen as a fuzzy membership function or a soft gating strategy. FIG. 4 shows a graphical representation of the sliding window's usage and the composition of the continuous function using the sinusoidal membership function for the fuzzification of the discrete events.

In the illustrated example, the sinusoidal membership function is chosen because it satisfies the following conditions:
tangent to the horizontal axis with a null value in both extremes;
bounded within the window;
with a unitary maximum value and tangent to the horizontal axis in the center;
symmetric and smooth;
with two inflection points located at the first and third quarters of the range;
with antisymmetric behavior in the change from the left corner until its first inflection point and the change from the inflection point to the center

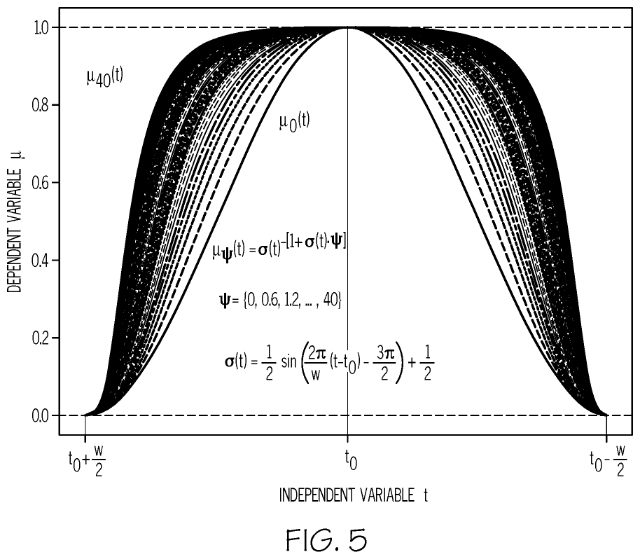

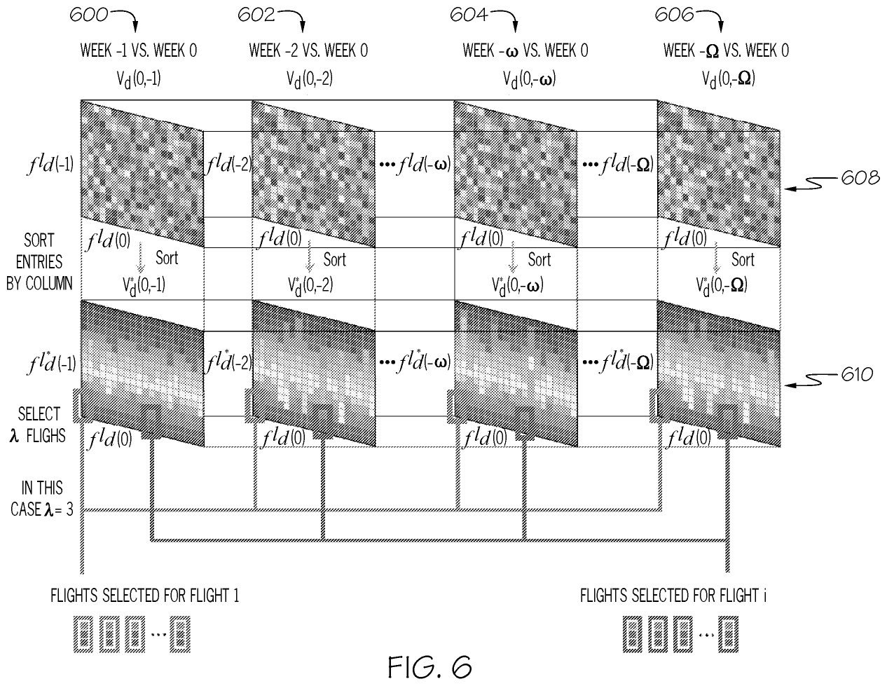

The Gaussian, Cauchy, or other membership functions with infinite range in the input dimension fail to satisfy these conditions. However, the sinusoidal membership function satisfies these conditions. In some examples, an exponent may be applied to each of the values of the sine function to make it flatter in the center or in the extremes at will. FIG. 5 depicts the shapes of different possibilities for the sinusoidal exponential membership function for the range of the sliding window. In the example of FIG. 5, the curves have been generated with the parameter ψ ranging from 0 to 40 in steps of 0.6. The tangency of the extremes and the center is preserved, as well as its symmetric nature and the values of the corners and the mid-point.

Referring back to FIG. 2, the flight similarity determination module 210 determines past flights that are similar to a particular flight being analyzed (for which a passenger flow prediction is to be made), as disclosed herein. The past flights may be used to predict passenger flow for the flight being analyzed. In particular, for a particular flight for which a passenger flow prediction is to be made, the computing device 101 may determine a weighted average of passenger flow data associated with a plurality of similar flights (e.g., flights that have similar passenger arrival patterns). As such, the flight similarity determination module 210 may determine which past flights have similar passenger arrival patterns to a flight being analyzed such that an appropriate weighted average may be performed. For example, when considering a Tuesday 8:00 AM flight to Boston, it may be useful to consider the Tuesday 8:00 A.M. flight to Boston that occurred Tuesday of previous weeks. However, it may also be useful to determine other flights that occurred on previous Tuesday either to Boston or to other destinations. As such, the flight similarity determination module 210 may determine which past flights have the most similar passenger flow profiles to the flight whose passenger flow is to be predicted, such that those flights may be used to make the prediction.

In the illustrated example, each day of the week is treated independently. That is, for a flight scheduled to depart on a Monday, only flights for previous Mondays will be considered. Flights for other days of the week are presumed to be less similar than flights on the same day of the week. As such, for a flight on a particular day of the week, the flight similarity determination module 210 will only consider past flights that took place on the same day of the week.

In the illustrated example, the index d refers to a particular day of the week. In the illustrated example, the flight similarity determination module 210 considers flights from the past Ω weeks, where Ω may be a user-specified parameter. The reference of the flights of the predicted day may be denoted as fl_{d}(0), where 0 is the index that identifies the week (e.g., 0 identifies flights occurring the same day as the flight being analyzed). Analogously, the reference of the flights of the same day ω weeks ago may be denoted as fl_{d}(−ω), where ω is bounded between 1 and Ω. In embodiments, the flight similarity determination module 210 builds an input similarity matrix V_{d}(0,−ω) that compares the flights of fl_{d}(0) and fl_{d}(−ω). This matrix is referred to as an input similarity matrix because it is based on input data associated with a flight (e.g., departure time, flight number, airline, and the like).

The flight similarity determination module 210 then sorts the entries of this input similarity matrix for each of the scheduled flights, thereby obtaining a sorted matrix V_{d}*(0,−ω) for each flight in fl_{d}(0). Finally, the flight similarity determination module 210 extracts the first λ flights of V_{d}*(0,−ω) for each scheduled flight in fl_{d}(0). The flight similarity determination module 210 may repeat this calculation for the last 22 weeks to obtain the set of flights that will be used to predict the future passenger flow for each scheduled flight in fl_{d}(0).

FIG. 6 graphically depicts the process performed by the flight similarity determination module 210. In the example of FIG. 6, the columns 600, 602, 604, and 606 graphically depict input similarity matrices between flights for week −1, week −2, week −ω, and week −Ω, respectively, and week 0. The similarity matrices in row 608 represent similarity matrices V_{d} and the similarity matrices in row 610 represent sorted similarity matrices V_{d}*. In the example similarity matrices of FIG. 6, each square represents a similarity score between a previous flight and a flight being analyzed, with a darker shading representing a higher similarity, which may be calculated as discussed below.

In embodiments, the flight similarity determination module 210 may determine an input similarity score between two flights a and b based on input features including boarding times of the two flights timeₐ and time_{b}, destinations of the two flights destₐ and dest_{b}, the airline or operating carrier of the two flights carrₐ and carr_{b}, the flight number of the two flights flnumₐ and flnum_{b}, and the number of seats of the two flights seatsₐ and seats_{b}. In particular, the flight similarity determination module 210 may determine the similarity score s_{a,b}ⁱⁿ between the two flights a and b using the following equation:

$${s}_{a , b}^{i n} = \frac{{v}_{a , b}^{time} + {v}_{a . b}^{d e s t} + {v}_{a , b}^{c a r r} + {v}_{a , b}^{f l n u m} + {v}_{a , b}^{s e a t s}}{5} ,$$

$$where {v}_{t i m e} = \frac{{w}_{1}}{{w}_{2} + \vert {time}_{a} - {time}_{b} \vert} ;$$

$${v}_{dest} = \{ \begin{matrix}{w}_{3} if {dest}_{a} = {dest}_{b} \\ 0 if {dest}_{a} \neq {dest}_{b}\end{matrix} ;$$

$${v}_{carr} = \{ \begin{matrix}{w}_{4} if {carr}_{a} = {carr}_{b} \\ 0 if {carr}_{a} \neq {carr}_{b}\end{matrix} ;$$

$${v}_{flnum} = \{ \begin{matrix}{w}_{5} if {flnum}_{a} = {flnum}_{b} \\ 0 if {flnum}_{a} \neq {flnum}_{b}\end{matrix} ;$$

$$and {v}_{s e a t s} = \frac{{w}_{6}}{{w}_{7} + \vert {seats}_{a} - {seats}_{b} \vert} .$$

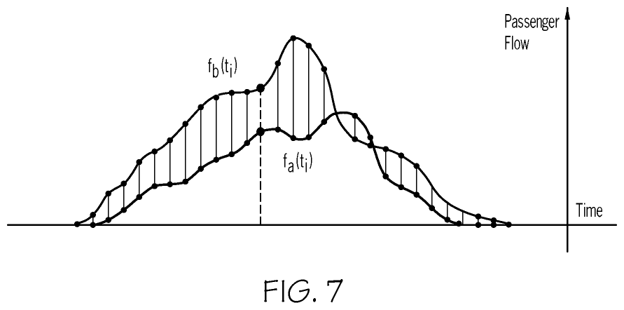

In the equation above, w₁, w₂, w₃, w₄, w₅, w₆, and w₇ are weights that are to be chosen, as disclosed herein. In particular, the weights may be determined such that two flights that have a high similarity score sun, have similar passenger flow profiles, as determined by the continuous distribution determination module 208 discussed above. Because an airport has a large number of flights, each having different parameters, the flight similarity determination module 210 may determine the weights in the above equation so as to minimize the difference between similarities for the entire set of comparisons between the flight being analyzed and past flights, as disclosed herein. To accomplish this, an output similarity between two passenger flow profiles output by the continuous distribution determination module 208, s_{a,b}^{out} may be determined using the following equation:

$${s}_{a , b}^{o u t} = \frac{1}{1 + \sqrt{\frac{1}{M} {{Σ}_{i = 1}^{M} [ {f}_{a} ( {t}_{i} ) - {f}_{b} ( {t}_{i} ) ]}^{2}}}$$

where M is the total number of points to be evaluated in the fa and fb curves representing passenger flow profiles for flights a and b. That is, the values of the passenger flow profiles for the flights and b are compared at each time ti, as shown in FIG. 7.

In embodiments, the genetic algorithm module 212 may determine the parameters w₁, w₂, w₃, w₄, w₅, w₆, and w₇ stochastically by solving this optimization problem using a Genetic Algorithm, as disclosed herein. In order to optimize the parameters, the genetic algorithm module 212 focuses only on weeks −1 to Ω. That is, the genetic algorithm module 212 excludes the week of the flight for which the prediction is being made since passenger flow profiles are not yet available for that week. Initially, the genetic algorithm module 212 computes all of the input similarity matrices for day d, V_{d}(−1, −ω), ω∈[−2, Ω]. The genetic algorithm module 212 also computes the output similarity matrices based on comparisons of the passenger flow profiles, denoted as F_{d}(−1, −ω), ω∈[−2, Ω]. The input similarity is based on the input features, which depend on the selection of the weights, which are variable through the optimization process, while the output similarity based on the outputs is fixed. By convention, the symbol V is used for variable and the symbol F is used for fixed.

The genetic algorithm module 212 then determines difference matrices, D_{d}, defined as D_{d}(−1, −ω)=V_{d}(−1, −ω)−F_{d}(−1, −ω), ω∈[r, c]. That is a difference matrix comprises a difference between an input matrix and an output matrix. The genetic algorithm module 212 then adds the information of each entry in these matrices defining a figure of accuracy ρ_{d}(−1, −ω) using the following equation:

$${ρ}_{d} ( - 1 , - ω ) = {\sum }_{c = 1}^{{n}_{c o l s}} {\sum }_{r = 1}^{{n}_{r o w s}} {D}_{d} ( - 1 , - ω ) [ r , c ]$$

where n_{cols} and n_{rows} are the dimensions of D_{d}(−1, −ω), which match with the length of fl_{d}(−1) and fl_{d}(−ω), respectively. Finally, the fitness function of the problem is the inverse of the average of the accuracies

$$\frac{1}{\overline{{ρ}_{d}}} .$$

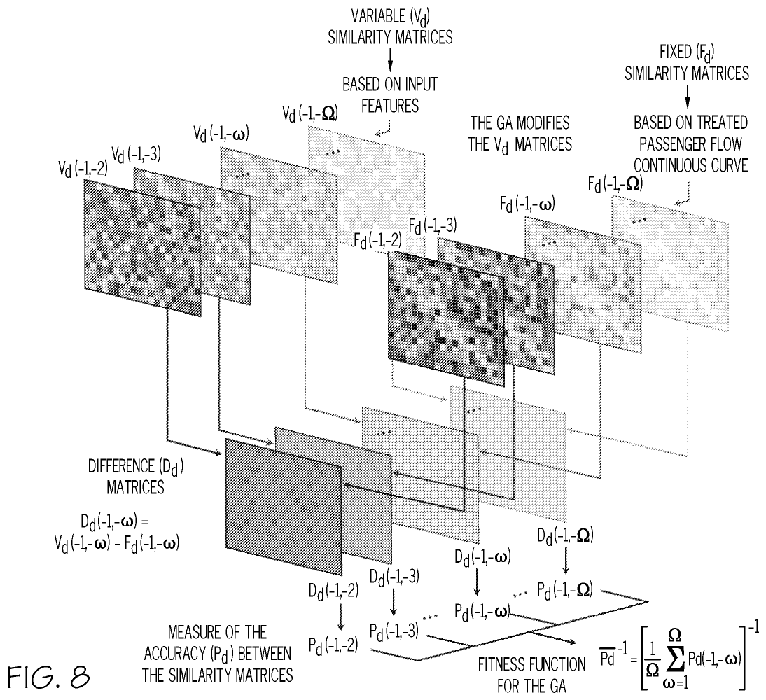

FIG. 8 shows a graphical representation of the calculation of the fitness value for the Genetic Algorithm.

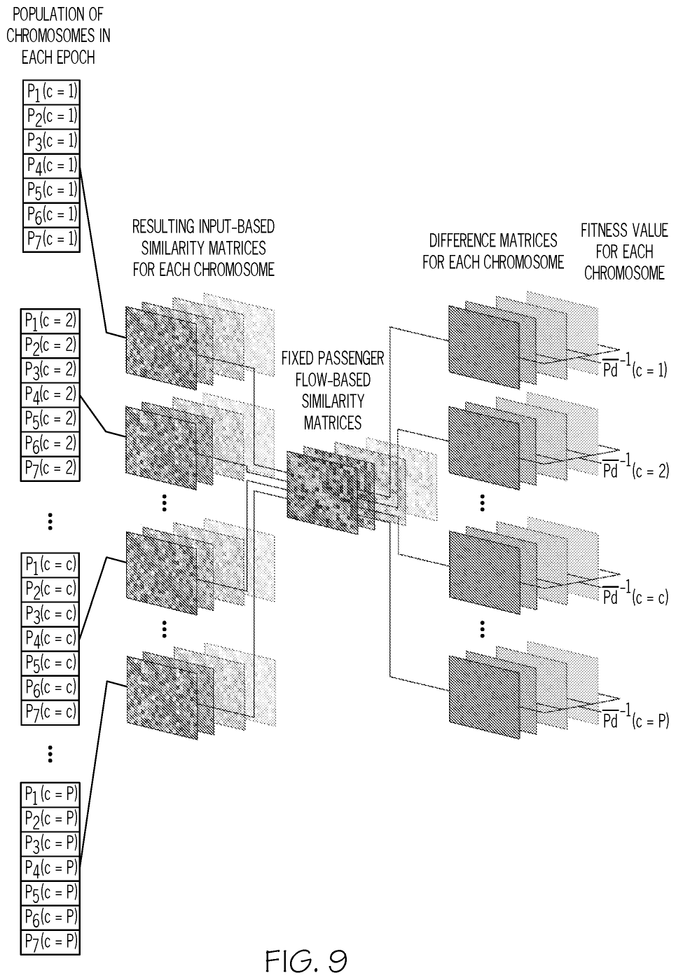

Each chromosome of the Genetic Algorithm has 7 genes that represent the weights for the calculation of the input data-based similarity matrices. Each chromosome generates a total of Ω−1 V_{d} matrices that are subsequently compared to the F_{d} matrices. Throughout the epochs of the evolution process, the F_{d} matrices may be stored and queried rather than re-generated at every iteration to reduce the needed computations. FIG. 9 shows an example generic population of chromosomes, their associated matrices, and the resulting fitness values obtained after the calculation of the D_{d} matrices. In the example of FIG. 9, each chromosome generates Ω−1 matrices of V_{d} type and Ω−1 matrices of Da type. In the end, the D_{d} matrices are converted into a fitness value that is used in the optimization process of the Genetic Algorithm.

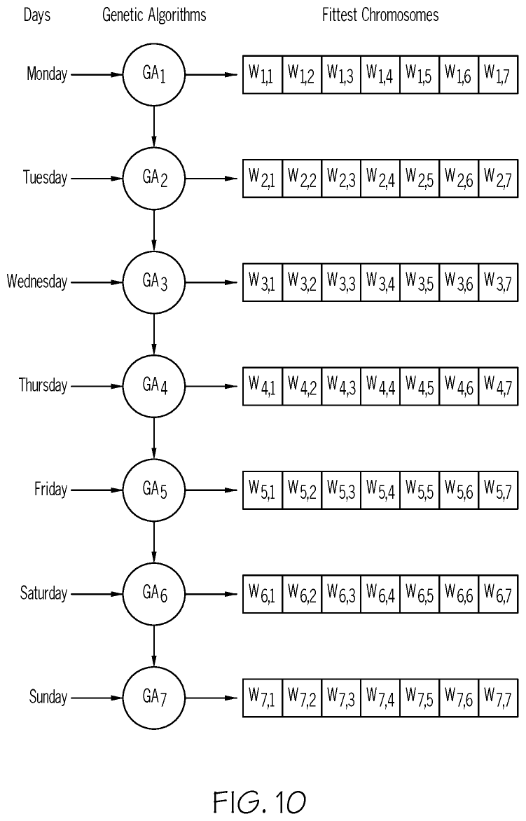

The discussion above has been with respect to a single day of the week, d. In embodiments, the genetic algorithm module 212 may carry out the same optimization process for each of the 7 calendar days of the week. That is, 7 Genetic Algorithms may obtain different optimal parameters for each day of the week. This results in 49 parameters (7 weights for each of 7 days). It may be desirable to occasionally correct and update the parameters. In the illustrated example, the parameters are re-optimized every week. However, in other examples, the parameters may be re-optimized after any time period. In embodiments, a recirculation of some of the fittest chromosomes from the prior Genetic Algorithm may be incorporated to reduce the computational cost, as shown in FIG. 10.

Referring back to FIG. 2, the seasonality scaling module 214 may be used to adjust passenger flow predictions for seasonality. As discussed above, passenger flow predictions for a flight may be made based on flights from previous weeks having similar passenger flow profiles. However, if a flight from a previous week occurred on a holiday, the data may not be applicable to a flight occurring in a different that is not a holiday. Accordingly, the seasonality scaling module 214 may account for such seasonality, as disclosed herein.

In particular, the seasonality scaling module 214 may utilize data from past years to scale the passenger flow profile curves of the current year so that fair comparisons between flights can be made. In embodiments, a load factor ξ_{y}(d(−ω)) for a day d of a week −ω for a year y may be defined as the ratio between the total number of passengers that came into the airport that day of the year, and the total number of seats available aggregating the seats for all flights for that day of the year, as shown in the following equation.

$${ξ}_{y} ( d ( - ω ) ) = \frac{Passengers for day d ( - ω ) in year y}{Seats for day d ( - ω ) in year y}$$

A load factor LF (f) for a particular flight f may be defined as the ratio between the number of passengers that boarded the flight f and the total number of seats available for that particular flight, as shown in the following equation.

$$L F ( f ) = \frac{Passengers boarded in f}{Seats available in f}$$

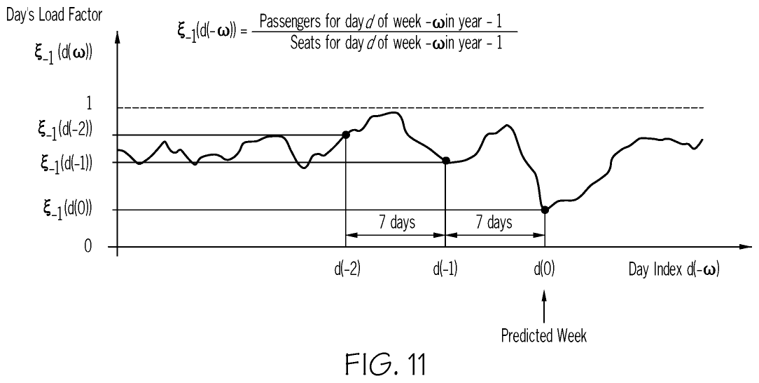

FIG. 11 shows an example daily evolution of an airport's load factor for each day (bounded between 0 and 1). The horizontal axis uses the day index d (−ω) to represent the ω^{th} week before the 0^{th} week for which a passenger flow prediction is being made.

The load factor for the day can be approximated as the average of the load factors of each individual flight that same day. If fl_{d,y}(−ω) represents the indices of the flights for that given day, and [f] identifies a specific entry in the vector, then

$${ξ}_{y} ( d ( - ω ) ) \approx \frac{1}{{n}_{flights}} {\sum }_{f = 1}^{{n}_{flights}} L F ( f {l}_{d , y} ( - ω ) [ f ] ) ,$$

$$with {n}_{flights} = \vert {fl}_{d , y} ( - ω ) \vert$$

Thus, when using the continuous passenger flow curves of a flight fl_{d,0}(−ω) for the prediction of fl_{d,0}(0) [g] (for a given g), the seasonality scaling module 214 may correct the load factor with the transformation β(⋅), considering the information from the previous year to the prediction ξ₋₁, as

$$β [ L F ( l {f}_{d , 0} ( - ω ) [ f ] ) ] = L F ( f {l}_{d , 0} ( - ω ) [ f ] ) \frac{{ξ}_{- 1} ( d ( 0 ) )}{{ξ}_{- 1} ( d ( - ω ) )}$$

Nevertheless, this transformation may result in a value that is bigger than 1, and all the load factors should be bounded between 0 and 1. Thus, the seasonality scaling module 214 may apply the following correction,

$$L {F}^{′} ( {fl}_{d , 0} ( - ω ) [ f ] ) = ϑ [ β [ L F ( f {l}_{d , 0} ( - ω ) [ f ] ) ] ]$$

$$where ϑ ( x ) = \{ \begin{matrix}1 if x > 1 \\ 0 if x < 0\end{matrix}$$

The corrected number of passengers P′(⋅) for that flight can be calculated from the total number of seats S(⋅), as

$${P}^{′} ( {fl}_{d , 0} ( - ω ) [ f ] ) = S ( f {l}_{d , 0} ( - ω ) [ f ] ) \cdot L {F}^{′} ( {fl}_{d , 0} ( - ω ) [ f ] )$$

Finally, the seasonality scaling module 214 may scale the curve with the factor k, as

$$k = \frac{L {F}^{′} ( {fl}_{d , 0} ( - ω ) [ f ] )}{L F ( f {l}_{d , 0} ( - ω ) [ f ] )} = \frac{ϑ [ β [ L F ( f {l}_{d , 0} ( - ω ) [ f ] ) ] ]}{L F ( f {l}_{d , 0} ( - ω ) [ f ] )} = \frac{ϑ [ L F ( f {l}_{d , 0} ( - ω ) [ f ] ) \cdot \frac{{ξ}_{- 1} ( d ( 0 ) )}{{ξ}_{- 1} ( d ( - ω ) )} ]}{L F ( f {l}_{d , 0} ( - ω ) [ f ] )}$$

The seasonality scaling module 214 may multiple each of the segments of the passenger profile curve by the factor k. For optimization purposes, the seasonality scaling module 214 may apply the scaling factors as the similarity matrices are being populated without storing the scaled curves. After the most similar flights are chosen, the seasonality scaling module 214 again performs the scaling to those curves that will be used for the prediction. As such, the seasonality scaling module 214 may account for seasonality in making passenger flow predictions.

Referring back to FIG. 2, the passenger flow prediction module 216 may predict passenger flow for a flight, as disclosed herein. In particular, the passenger flow prediction module 216 may predict passenger flow for a flight based on similar past flights determined by the flight similarity determination module 210 and scaled by the seasonality scaling module 214. In embodiments, the passenger flow prediction module 216 may determine a weighted average of the passenger profile curves for the most similar flights determined by the flight similarity determination module 210, as adjusted by the seasonality scaling module 214. As such, the passenger flow prediction module 216 may determine a predicted passenger profile curve for a flight. The passenger flow prediction module 216 may similarly predict a passenger profile curve for any number of scheduled flights.

Referring still to FIG. 2, the discrete distribution determination module 218 may transform the continuous passenger profile curve determined by the passenger flow prediction module 216 into a histogram comprising a discrete distribution of TUTO data points for a flight. Effectively, the discrete distribution determination module 218 may perform the opposite function of the continuous distribution determination module 208. That is, while the continuous distribution determination module 208 transforms a passenger flow histogram into a continuous passenger profile curve, the discrete distribution determination module 218 transforms a continuous passenger profile curve into a passenger flow histogram. While a continuous passenger flow curve is more appropriate for performing the operations of the passenger prediction algorithm described herein, a histogram may be better suited for presenting the results of the prediction algorithm. Thus, the discrete distribution determination module 218 may determine a passenger flow histogram, as disclosed herein.

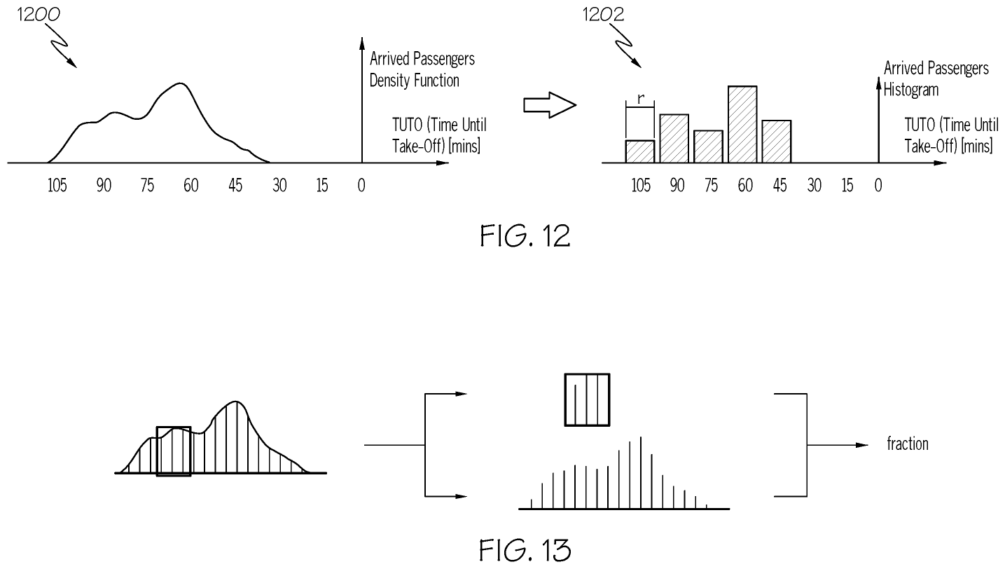

In embodiments, the width of the histogram bars is represented by the variable r. In the illustrated example, the value of r is set at 15 minutes. However, in other examples, other intervals may be used for the value of r. In addition, in the illustrated example, the discrete distribution determination module 218 determines the histogram for intervals up to 3 hours before a scheduled flight, such that passenger arriving more than 3 hours before their flight would not be considered. However, in other examples, other lengths of time before scheduled flights may be considered. FIG. 12 graphically depicts a transformation from a continuous passenger flow profile curve 1200 to a passenger flow histogram 1202.

To perform the transformation, the discrete distribution determination module 218 considers the sum of segments within each bin of the histogram (as defined by the resolution r), and divides this sum by the total sum of segments under the area, resulting a fraction, as depicted in FIG. 13. The discrete distribution determination module 218 then adds or subtracts a fraction of any variance of the segments enclosed within a bin if there is a peak or a valley within the bin, respectively. The variance may also be weighted by the proximity of the peak or valley to the center of the bin, making a zero contribution if these occur in either extreme of the bin and maximum if in the center.

Lastly, the discrete distribution determination module 218 performs an iterative algorithm to get integer predictions in the histogram's bars, as the predicted number of passengers in each time interval should be a whole number. In particular, the discrete distribution determination module 218 divides the fractional portion of the bins so that the entire histogram adds up to the total number of people forecasted for a particular flight.

The discrete distribution determination module 218 begins this iterative algorithm by rounding the bar whose fractional value is closest to an integer value. The remaining fractional mass (negative or positive) that has been added or subtracted is shared between the two neighbor bars equally (provided that these bars are still fractional). If there is only one neighbor bar with fractional values, then the mass is transmitted fully to this bar. If there are no neighbor bars with fractional values, then the mass is discarded. After applying this to one bar, the discrete distribution determination module 218 applies the same process to all of the remaining non-integer bars. The remaining mass with number of people to distribute along the bars is applied at each step.

Referring back to FIG. 2, the flight prediction merging module 220 may merge histogram data determined by the discrete distribution determination module 218 from multiple flights. As discussed above, the discrete distribution determination module 218 outputs a histogram representing predicted passenger flow for one particular flight. However, it may be more useful to predict passenger flow for an entire airport terminal of an airport. As such, the flight prediction merging module 220 may merge the histograms for all flights of a given day at an airport terminal to generate a histogram representing predicted passenger flow for the terminal during one day.

Referring still to FIG. 2, the dynamic updating module 222 may dynamically update passenger flow predictions at an airport based on actual data retrieved during the day of flights for which predictions were made. As disclosed above, the computing device 101 may predict passenger flow for one or more flights based on previous flights that are expected to have similar passenger flow profiles. As such, the predictions may be made a day or more ahead of time. However, during the actual day of the flight, as actual passenger flow data is gathered, the predictions may be updated based on this data, as disclosed herein.

In the illustrated example, the dynamic updating module 222 uses the Cluster-first Explainable FuzzY-based Deep self-Reorganizing Algorithm (CEFYDRA) to dynamically update passenger flow predictions. However, in other examples, other algorithms may be used. CEFYDRA is capable of making predictions in multiple input and multiple output problems. As such, CEFYDRA may be used to extract a linear approximation that was triggered for each of the multiple outputs. The dynamic updating module 222 may utilize these results to dynamically update the passenger flow predictions.

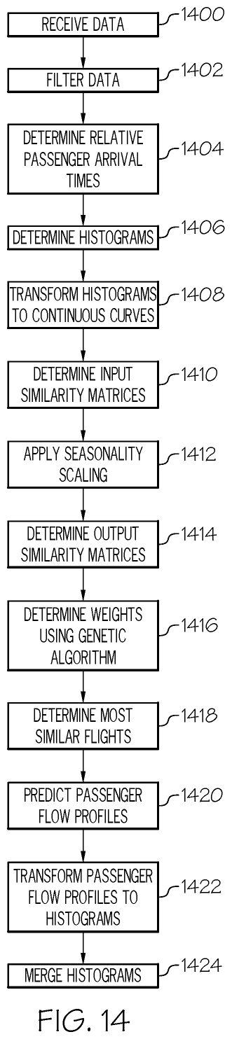

FIG. 14 depicts a flowchart of an example method that may be performed by the computing device 101 to predict airport passenger flow. At step 1400, the data retrieval module 200 receives data from the scanning device 120 comprising non-identifiable information about airline passengers and flights determined by the scanning device 120 based on scans of boarding passes. In the illustrated example, the data received by the data retrieval module 200 may include, for each scan of a passenger's boarding pass, a flight number, a departure date and time, a destination airport, an airline, and a time that the scan occurred. The data retrieved by the data retrieval module 200 may be stored in the data storage component 108. In the illustrated example, the data retrieval module 200 receives data from the scanning device 120 once per day. However, in other examples, the data retrieval module 200 may receive data from the scanning device 120 at other intervals.

At step 1402, the data preprocessing module 202 filters the data received by the data retrieval module 200. In the illustrated example, the data preprocessing module 202 may remove data having missing or invalid information, remove duplicate entries, and sort data entries by flight. In other examples, the data preprocessing module 202 may perform other types of data preprocessing.

At step 1404, the relative arrival time determination module 204 determines relative arrival times of passengers for one or more flights with respect to the departure times of the flights based on the data received by the data retrieval module 200. In particular, for each scan of a boarding pass performed by the scanning device 120 for one or more flights, the relative arrival time determination module 204 determines how many minutes before the scheduled flight associated with the boarding pass that the boarding pass was scanned (the TUTO).

At step 1406, the histogram determination module 206 determines histograms comprising TUTOs of passengers for one or more flights. In the illustrated example, for each of one or more flights, the histogram determination module 206 determines a histogram comprising a number of passengers whose boarding pass was scanned in each 15 minute interval before the scheduled departure time. However, in other examples, the histogram determination module 206 may determine histograms based an interval other than 15 minutes.

At step 1408, the continuous distribution determination module 208 transforms one or more histograms determined by the histogram determination module 206 to continuous passenger profile curves using the techniques described above. In particular, the continuous distribution determination module 208 determines a continuous curve that approximates the TUTOs for the passengers of one or more flights.

At step 1410, the flight similarity determination module 210 determines one or more input similarity matrices between a flight whose passenger flow profile is to be predicted and a plurality of past flights using the techniques described above. In particular, the flight similarity determination module 210 determines input similarity matrices indicating an input similarity between the flight to be predicted and a plurality of past flights that took place on the same day in previous weeks.

At step 1412, the seasonality scaling module 214 applies seasonality scaling to the passenger profile curves determined by the continuous distribution determination module 208 using the techniques described above. In particular, the seasonality scaling module 214 adjusts the passenger profile curves for flights based on passenger profile curves that occurred on the same day in previous years. This may adjust the passenger profile curves for holidays so that they can be properly compared to other passenger profile curves on non-holidays.

At step 1414, the flight similarity determination module 210 determines one or more output similarity matrices between the flight whose passenger flow profile is to be predicted and a plurality of past flights using the techniques described above. The output similarity matrices may be determined based on a comparison of passenger flow profiles between different flights as scaled by the seasonality scaling module 214. In particular, the flight similarity determination module 210 determines output similarity matrices indicating an output similarity between the flight to be predicted and the plurality of past flights for which the input similarity matrices were determined.

At step 1416, the genetic algorithm module 212 uses a genetic algorithm to determine the weights to be used for the parameters of the input similarity score as described above. In particular, the genetic algorithm module 212 uses a genetic algorithm to determine the weights to be used for the input similarity score such that the difference between the input similarity matrices and the output similarity matrices are minimized.

Ag step 1418, the flight similarity determination module 210 determines a predetermined number of past flights that have the highest similarity score to the flight to be predicted using the weights determined by the genetic algorithm module 212. At step 1420, the passenger flow prediction module 216 predicts a passenger flow profile for the flight to be predicted based on the flights having the highest similarity score as determined by the flight similarity determination module 210. In particular, the passenger flow prediction module 216 determines a weighted average of the passenger flow profiles of the most similar previous flights. As such, the passenger flow prediction module 216 determines a predicted continuous passenger flow profile for a flight. The passenger flow prediction module 216 may similarly predict a passenger flow profile for any number of flights.

At step 1422, the discrete distribution determination module 218 determines the passenger flow profiles predicted by the passenger flow prediction module 216 to passenger flow histograms using the techniques described above. In the illustrated example, for each of one or more flights, the discrete distribution determination module 218 determines a histogram indicating a predicted number of passengers having a TUTO within each 15 minute interval before the scheduled flights. However, in other examples, the discrete distribution determination module 218 may determine a histogram indicating the predicted number of passengers having a TUTO within other interval lengths.

At step 1424, the flight prediction merging module 220 merges histograms determined by the discrete distribution determination module 218 for a plurality of flights scheduled to depart on the same day from the same airport terminal. As such, the flight prediction merging module 220 may generate a histogram predicting passenger flow for one day for the entire airport terminal.

It should now be understood that embodiments described herein are directed to systems and methods for predicting airport passenger flow. Embodiments disclosed herein solve the technical problem of predicting the number of passengers expected to pass through an airport at different times of the day based on past data associated with passengers arriving at an passing through an airport.

In embodiments described herein, a scanning device may scan passenger boarding passes and extract data associated with those passengers' scheduled flights. A computing device may predict passenger flow for an upcoming flight based on data regarding passenger flow for past flights that took place on the same day of the week. A genetic algorithm may be used to determine past flights that are most similar to the upcoming flight and those most similar flights may be used to predict passenger flow for the upcoming flight.

After passenger flow is predicted for an upcoming flight, this data can be shared with airports, airlines, or the TSA, among other entities. These entities may use this data to allocate resources for particular times during the day. For example, passenger flow prediction data may be used to determine how many security checkpoints to open at different times, how many staff members should be working at different times, how lines at check-in or security check points should be arranged, when to open and how many staff to use at airport restaurants, and the like.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A computing device comprising a controller configured to:
receive passenger data associated with a plurality of passengers based on scans of boarding passes associated with the plurality of passengers at an airport;
determine time until takeoff data for the plurality of passengers based on the passenger data, the time until takeoff data for a passenger comprising a relative difference between a time when the passenger's boarding pass was scanned and a departure time of a flight associated with the passenger's boarding pass;
determine one or more passenger flow histograms for one or more flights based on the time until takeoff data, each passenger flow histogram indicating a number of passengers having a time until takeoff within each of a predetermined number of time intervals before a scheduled flight;
transform the passenger flow histograms into one or more continuous passenger flow profile curves;
determine one or more input similarity matrices between a first flight and a plurality of past flights based on input similarity scores between the first flight and the plurality of past flights, the first flight and the past flights having scheduled departures on the same day of the week;
determine one or more output similarity matrices between the first flight and the plurality of past flights based on passenger flow profile curves associated with the first flight and the plurality of past flights;
determine a predetermined number of the plurality of past flights that are most similar to the first flight based on the one or more input similarity matrices and the one or more output similarity matrices; and
determine a predicted passenger flow profile curve for the first flight based on the passenger flow profile curves associated with the predetermined number of the plurality of past flights.

2. The computing device of claim 1, wherein the passenger data comprises a flight number, a departure date and time, a destination airport, and an airline associated with a passenger's scheduled flight, and a time that the passenger's boarding pass was scanned.

3. The computing device of claim 1, wherein the controller is further configured to remove entries from the passenger data having missing information or duplicate entries.

4. The computing device of claim 1, wherein the controller is further configured to transform the passenger flow histograms into the one or more continuous passenger flow profile curves using a sinusoidal membership function.

5. The computing device of claim 1, wherein the input similarity score between the first flight and a past flight is based on a difference in departure times between the first flight and the past flight, a difference in a number of seats between the first flight and the past flight, whether the first flight and the past flight have the same destination, whether the first flight and the past flight have the same airline, whether the first flight and the past flight have the same flight number, and a plurality of weights.

6. The computing device of claim 5, wherein the controller is further configured to:
determine one or more difference matrices between the input similarity matrices and the output similarity matrices; and
determine values of the plurality of weights such that values of the difference matrices are minimized.

7. The computing device of claim 6, wherein the controller is further configured to determine the weights using a genetic algorithm.

8. The computing device of claim 1, wherein the controller is further configured to:
determine seasonally adjusted passenger flow profile curves based on the one or more continuous passenger flow profile curves and data associated with flights from one or more previous years; and
determine the one or more output similarity matrices based on the seasonally adjusted passenger flow profile curves.

9. The computing device of claim 1, wherein the controller is further configured to determine the predicted passenger flow profile curve for the first flight based on a weighted average of the passenger flow profile curves associated with the predetermined number of the plurality of past flights.

10. The computing device of claim 1, wherein the controller is further configured to transform the predicted passenger flow profile curve for the first flight to a predicted passenger flow histogram associated with the first flight.

11. The computing device of claim 10, wherein the controller is further configured to merge the predicted passenger flow histogram associated with the first flight and one or more other passenger flow histograms associated with one or more other flights scheduled to depart from the same airport terminal on the same day as the first flight to generate a second passenger flow histogram associated with a plurality of flights.

12. The computing device of claim 10, wherein the controller is further configured to:
receive actual passenger flow data associated with the first flight on the day that the first flight is scheduled to depart; and
update the predicted passenger flow histogram associated with the first flight based on the actual passenger flow data.

13. A method comprising:
receiving passenger data associated with a plurality of passengers based on scans of boarding passes associated with the plurality of passengers at an airport, the passenger data comprising a flight number, a departure date and time, a destination airport, and an airline associated with a passenger's scheduled flight, and a time that the passenger's boarding pass was scanned;
determining time until takeoff data for the plurality of passengers based on the passenger data, the time until takeoff data for a passenger comprising a relative difference between a time when the passenger's boarding pass was scanned and a departure time of a flight associated with the passenger's boarding pass;
determining one or more passenger flow histograms for one or more flights based on the time until takeoff data, each passenger flow histogram indicating a number of passengers having a time until takeoff within each of a predetermined number of time intervals before a scheduled flight;
transforming the passenger flow histograms into one or more continuous passenger flow profile curves;
determining one or more input similarity matrices between a first flight and a plurality of past flights based on input similarity scores between the first flight and the plurality of past flights, the first flight and the past flights having scheduled departures on the same day of the week;
determining one or more output similarity matrices between the first flight and the plurality of past flights based on passenger flow profile curves associated with the first flight and the plurality of past flights;
determining a predetermined number of the plurality of past flights that are most similar to the first flight based on the one or more input similarity matrices and the one or more output similarity matrices; and
determining a predicted passenger flow profile curve for the first flight based on the passenger flow profile curves associated with the predetermined number of the plurality of past flights.

14. The method of claim 13, further comprising transforming the passenger flow histograms into the one or more continuous passenger flow profile curves using a sinusoidal membership function.

15. The method of claim 13, wherein the input similarity score between the first flight and a past flight is based on a difference in departure times between the first flight and the past flight, a difference in a number of seats between the first flight and the past flight, whether the first flight and the past flight have the same destination, whether the first flight and the past flight have the same airline, whether the first flight and the past flight have the same flight number, and a plurality of weights.

16. The method of claim 15, further comprising:
determining one or more difference matrices between the input similarity matrices and the output similarity matrices; and
using a genetic algorithm to determine the weights such that values of the difference matrices are minimized.

17. The method of claim 13, further comprising:
determining seasonally adjusted passenger flow profile curves based on the one or more continuous passenger flow profile curves and data associated with flights from one or more previous years;
determining the one or more output similarity matrices based on the seasonally adjusted passenger flow profile curves; and
determining the predicted passenger flow profile curve for the first flight based on a weighted average of the passenger flow profile curves associated with the predetermined number of the plurality of past flights.

18. The method of claim 13, further comprising transforming the predicted passenger flow profile curve for the first flight to a predicted passenger flow histogram associated with the first flight; and
merging the predicted passenger flow histogram associated with the first flight and one or more other passenger flow histograms associated with one or more other flights scheduled to depart from the same airport terminal on the same day as the first flight to generate a second passenger flow histogram associated with a plurality of flights.

19. The method of claim 18, further comprising:
receiving actual passenger flow data associated with the first flight on the day that the first flight is scheduled to depart; and
updating the predicted passenger flow histogram associated with the first flight based on the actual passenger flow data.

20. A system comprising:
a scanning device configured to scan boarding passes of airport passengers; and
a computing device configured to:
receive passenger data associated with a plurality of passengers from the scanning device;
determine time until takeoff data for the plurality of passengers based on the passenger data, the time until takeoff data for a passenger comprising a relative difference between a time when the passenger's boarding pass was scanned and a departure time of a flight associated with the passenger's boarding pass;
determine one or more passenger flow histograms for one or more flights based on the time until takeoff data, each passenger flow histogram indicating a number of passengers having a time until takeoff within each of a predetermined number of time intervals before a scheduled flight;
transform the passenger flow histograms into one or more continuous passenger flow profile curves;
determine one or more input similarity matrices between a first flight and a plurality of past flights based on input similarity scores between the first flight and the plurality of past flights, the first flight and the past flights having scheduled departures on the same day of the week;
determine one or more output similarity matrices between the first flight and the plurality of past flights based on passenger flow profile curves associated with the first flight and the plurality of past flights;
determine a predetermined number of the plurality of past flights that are most similar to the first flight based on the one or more input similarity matrices and the one or more output similarity matrices; and
determine a predicted passenger flow profile curve for the first flight based on the passenger flow profile curves associated with the predetermined number of the plurality of past flights.
